(19) United States
(12) Patent Application Publication
(10) Pub. No.: US 2016/0290561 A1
(43) Pub. Date: Oct. 6, 2016

(54) SYSTEM AND METHOD FOR INTELLIGENT REFUELLING OF A PRESSURISED VESSEL

(71) Applicant: MOSAIC TECHNOLOGY DEVELOPMENT PTY LTD, Brisbane, Queensland (AU)

(72) Inventors: Paul Anthony WHITEMAN, Brisbane (AU); Derek Shane FEKETE, Brisbane (AU)

(21) Appl. No.: 15/036,973

(22) PCT Filed: Nov. 18, 2014
(86) PCT No.: PCT/AU2014/050356

§ 371 Date: May 16, 2016

(30) Foreign Application Priority Data
Nov. 18, 2013 (AU) 2013904442

(51) Int. Cl. F17C 5/00; F17C 13/02; F17C 5/06

(52) U.S. Cl. CPC F17C 5/007; F17C 5/06; F17C 13/025; F17C 13/026; F17C 13/023; F17C 2201/0104; F17C 2205/0142; F17C 2205/0326; F17C 2205/0335; F17C 2205/0394; F17C 2221/033; F17C 2227/036; F17C 2250/032; F17C 2250/0421; F17C 2250/043; F17C 2250/0439; F17C 2250/0694; F17C 2250/075; F17C 2260/023; F17C 2265/065; F17C 2270/0168; F17C 2270/0171; F17C 2270/0176; F17C 2270/0173

(57) ABSTRACT

A system and method enable intelligent refuelling of a pressurised vessel. The method includes receiving a gas at a refuelling port, wherein the refuelling port is coupled to the pressure vessel; determining a temperature 5 of the pressure vessel; determining a pressure of the pressure vessel; directing the gas through a nozzle, wherein the pressure vessel and nozzle are thermally coupled such that Joule-Thomson expansion of a gas flowing through the nozzle cools an interior cavity of the pressure vessel; and controlling a shut-off valve according to an amount of gas in the pressure 10 vessel determined according to the temperature and pressure, wherein the shut-off valve is located between the refuelling port and the pressure vessel, for controlling a flow of gas between the refuelling port and the pressure vessel.

### FIELD OF THE INVENTION

This invention relates generally to compressed gas systems and methods. In particular, the invention relates to a compressed natural gas system and method for use in vehicles in general and particularly commercial vehicles such as prime movers, trucks, buses and trains.

### BACKGROUND OF THE INVENTION

Natural gas fuels are relatively environmentally friendly for use in vehicles, and hence there is support by environmental groups and governments for the use of natural gas fuels in vehicle applications. Natural gas based fuels are commonly found in three forms: Compressed Natural Gas (CNG), Liquefied Natural Gas (LNG) and a derivative of natural gas called Liquefied Petroleum Gas (LPG).

Natural gas fuelled vehicles have impressive environmental credentials as they generally emit very low levels of SO₂ (sulphur dioxide), soot and other particulate matter. Compared to gasoline and diesel powered vehicles, CO₂ (carbon dioxide) emissions of natural gas fuelled vehicles are often low due to a more favourable carbon-hydrogen ratio found in natural gas. Natural gas vehicles come in a variety of forms, from small cars to (more commonly) small trucks and buses. Natural gas fuels also provide engines with a longer service life and lower maintenance costs. Further, CNG is the least expensive alternative fuel when comparing equal amounts of fuel energy. Still further, natural gas fuels can be combined with other fuels, such as diesel, to provide similar benefits mentioned above.

A key factor limiting the use of natural gas in vehicles is the storage of the natural gas fuel. In the case of CNG and LNG, the fuel tanks are generally expensive, large and cumbersome relative to tanks required for conventional liquid fuels having the same energy content. In addition, the lack of wide availability of CNG and LNG refuelling facilities, and the cost of LNG, add further limitations on the use of natural gas as a motor vehicle fuel. Further, in the case of LNG, the cost and complexity of producing LNG and issues associated with storing a cryogenic liquid on a vehicle further limits the widespread adoption of this fuel.

Some of the above issues are mitigated concerning LPG, and this fuel is widely used in high mileage motor cars such as taxis. However, cost versus benefit comparisons are often not as favourable in the case of private motor cars. Issues associated with the size and shape of the fuel tank, the cost variability of LPG and the relatively limited supply mean that LPG also has significant disadvantages that limit its widespread adoption. Consequently, without massive investment in a network of LNG plants around major transport hubs, CNG is the only feasible form of natural gas that is likely to be widely utilised in the near future.

However, some technical problems still limit the efficiency of CNG fuel systems. For example, the pressure to which composite CNG cylinders can be filled at a typical CNG re-fuelling station is limited because the heat of compression can cause overheating of cylinders being filled. This has typically meant that 245 bar at 21 degrees Celsius (settled temperature) is the limit for composite ONG cylinder filling, and has become the standard adopted in many parts of the world including the US.

In the US, codes typically allow for filling to an overpressure of 1.25 times the pressure rating of the CNG cylinder provided it would subsequently settle to 245 bar when cooled to 21 deg. C. The code also identifies in-cylinder heating as having the potential to cause transient temperature excursions exceeding cylinder design parameters. This limits current fast filling practices of CNG cylinders, such that fills of between 70% and 80% of cylinder “name plate” ratings are often all that can be achieved, particularly with large CNG cylinders. This has a significant detrimental impact on the range of CNG vehicles, and also on consumers who generally have insufficient information on board the vehicle to quantify the variability of a CNG cylinder fill and the impacts on vehicle range.

Also, the variability and inability to fully fill CNG cylinders has a major impact on the use of CNG cylinders in bulk gas transport, where poor CNG cylinder filling has significant commercial impact on the cost of gas delivered,

For example, in Europe, the relevant codes limit the maximum pressure in composite CNG cylinders during re-fuelling to 260 barg to ensure maximum design temperatures are not exceeded. These limitations mean that the currently available composite cylinders designed for 350 barg operating pressure and above could not be utilised in conventional CNG re-fuelling systems. Thus the opportunity to utilise smaller CNG cylinders, or to achieve increases in vehicle range, or improved commercial outcomes for gas transport, using the same size fuel cylinders, can not be realised.

A further problem with some CNG systems of the prior art is that pressure compensation, and sometimes ambient temperature compensation, is used to estimate an amount of CNG fuel in cylinders, both when refuelling and in use. CNG tanks cool as CNG is consumed due to expansion of the remaining CNG, and conversely become hot during filling. Both scenarios cause significant divergence from ambient temperature, which results in inaccurate pressure compensation. The amount of CNG in a cylinder thus becomes indeterminate, the refuelled amount variable and unreliable, and the vehicle fuel gauge highly inaccurate. This results in frequent miscalculations of vehicle range, and consequent running out of fuel events, in both commercial and consumer CNG vehicles.

Certain systems of the prior art attempt to provide improved refuelling of CNG cylinders through the use of smart dispensers that communicate with pressure and temperature sensors on the vehicle CNG cylinders. Such systems are, however, complex and expensive, and are thus not particularly suited to commercial CNG applications.

There is therefore a need for an improved compressed natural gas vehicle storage, refuelling, and fuel management system and method.

### OBJECT OF THE INVENTION

It is an object of some embodiments of the present invention to provide improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a vehicle mounted system for receiving a compressed gas, the system comprising:

a refuelling port, for receiving the compressed gas;

a pressure vessel, coupled to the refuelling port, for storing the compressed gas;

a shut-off valve, between the refuelling port and the pressure vessel, for controlling a flow of gas between the refuelling port and the pressure vessel;

a pressure sensor for determining a pressure inside the pressure vessel;

a temperature sensor for determining a temperature associated with the pressure vessel;

a nozzle, wherein the pressure vessel and nozzle are thermally coupled such that Joule-Thomson expansion of a gas flowing through the nozzle cools an interior cavity of the pressure vessel; and

a controller coupled to the pressure sensor, the temperature sensor and the shut-off valve, the controller configured to selectively activate the shut-off valve according to an amount of gas in the pressure vessel determined according to values of the pressure sensor and the temperature sensor,

Preferably, the controller is further configured to activate the shut-off valve when a pressure of the pressure vessel is above a predefined pressure threshold. Suitably, the predefined pressure threshold is about 1.25 times the nominal service pressure of the pressure vessel, or 310 barg for a 250 barg system and 438 barg for a 350 barg system.

Preferably, the controller is further configured to activate the shut-off valve when a temperature of the pressure vessel is above a predefined temperature threshold. Suitably, the predefined temperature threshold is 82° C.

Preferably, the amount of gas is determined according to a map that maps a temperature to a pressure. Suitably, the map includes a plurality of pressure-temperature pairs, wherein each of the plurality of pressure-temperature pairs corresponds to an amount of CNG, which, if allowed to cool to 21° C., would equal about the nominal service pressure of the pressure vessel, or 350 barg depending on the rating of the pressure vessel.

Preferably, the map corresponds to a mathematical function that includes pressure, temperature and gas composition as input variables.

Preferably, the system further comprises a plurality of pressure vessels, wherein the refuelling port is coupled to the plurality of pressure vessels.

Preferably, the system includes a header pressure sensor for determining a pressure of a gas header connected to an inlet port of each vessel of the plurality of pressure vessels.

Preferably, the controller is further configured to control the shut off valve according to a pressure in the gas header. Suitably, the controller is configured to activate the shut-off valve when a pressure of the as header is below a predefined threshold.

Preferably, the system comprises a plurality of pressure vessels, wherein each of the plurality of pressure vessels comprises a nozzle, and wherein the nozzles are each calibrated such that the plurality of pressure vessels fill at a same rate.

Preferably, the refuelling port comprises a 350 barg connector and a 250 barg connector.

Preferably, the controller is further configured to calculate a mass of gas in the pressure vessel according to the sensors and volume of the pressure vessel, and provide an indication of a diesel gallon equivalent (DGE) of the gas in the pressure vessel on an output interface.

Preferably, the pressure vessel is a compressed natural gas (CNG) pressure vessel.

Preferably, the system is adapted to be used with a simple dispenser that shuts off refuelling based on a cessation of flow of gas.

Preferably, the temperature sensor is positioned at one end of the pressure vessel and the nozzle is positioned at an opposite end of the pressure vessel, to enable accurate determination of the temperature of the gas inside the pressure vessel.

In another form, the invention resides in a method of filling of a pressure vessel on board a vehicle including: receiving a gas at a refuelling port, wherein the refuelling port is coupled to the pressure vessel;

determining a temperature of the pressure vessel;

determining a pressure of the pressure vessel;

directing the gas through a nozzle, wherein the pressure vessel and nozzle are thermally coupled such that Joule-Thomson expansion of a gas flowing through the nozzle cools an interior cavity of the pressure vessel; and

controlling a shut-off valve according to an amount of gas in the pressure vessel determined according to the temperature and pressure, wherein the shut-off valve is located between the refuelling port and the pressure vessel, for controlling a flow of gas between the refuelling port and the pressure vessel.

### BRIEF DESCRIPTION OF THE DRAWINGS

An embodiment of the invention will be described with the reference to the accompanying drawings in which:

FIG. 1 diagrammatically illustrates a CNG storage system, according to certain embodiments of the present invention;

FIG. 2 diagrammatically illustrates a control portion of the system of FIG. 1, according to an embodiment of the present invention;

FIG. 3 illustrates a CNG storage system, according to certain embodiments of the present invention;

FIG. 4 illustrates a method of filling a pressure vessel, according to an embodiment of the present invention; and

FIG. 5 diagrammatically illustrates a controller, according to an embodiment of the present invention.

### DETAILED DESCRIPTION OF THE PREFERRED EMBODIMENT

Embodiments of the present invention comprise compressed gas systems and methods. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given byway of example only.

The reference to any prior art in this specification is not, and should not be taken as, an acknowledgement or any form of suggestion that the prior art forms part of the common general knowledge.

In one form, the invention resides in a vehicle mounted system for receiving a compressed natural gas, the system comprising; a refuelling port, for receiving the compressed gas; a pressure vessel, coupled to the refuelling port, for storing the compressed gas; a shut-off valve, between the refuelling port and the pressure vessel, for controlling a flow of gas between the refuelling port and the pressure vessel; a pressure sensor for determining a pressure associated with the pressure vessel; a temperature sensor for determining a temperature associated with the pressure vessel; a nozzle, wherein the pressure vessel and nozzle are thermally coupled such that Joule-Thomson expansion of a gas flowing through the nozzle cools an interior cavity of the pressure vessel; and a controller coupled to the sensors and the shut-off valve, the controller configured to selectively activate the shut-off valve according to values of the pressure sensor and temperature sensor.

Advantages of certain embodiments of the present invention include an ability to efficiently and reliably re-fuel CNG storage cylinders and achieve performance benchmarks that equal or exceed the performance claims for storage, space claim and weight of existing LNG systems. This can in turn enable the large scale take up of CNG as an alternative fuel to diesel.

Certain embodiments of the present invention enable CNG fuel tanks on board a vehicle to be quickly and efficiently filled. In particular, certain embodiments of the present invention enable CNG fuel tanks to store up to 80% more fuel than is currently possible using conventional 200/250 barg fast filled systems, without using more space on the vehicle.

Thus some embodiments of the present invention include an intelligent fuel pack (IFP) that is a completely self-contained and managed CNG fuel package that ensures as full a fill as is possible with any given supply of gas to the fuel pack. The IFP maximises the Joule Thompson cooling impact via a nozzle in-cylinder and maximises the fill by filling to the limits of maximum temperature, maximum pressure, or 100% full as determined via a lookup 3D map of X-temperature, Y-pressure, Z-% full. The 3D map essentially is a representation of conditions at which the cylinder will settle to 100% of its nominal service pressure at its nominal service temperature. If required the 3D map can be determined empirically to take into account uneven temperature mixing in the fuel cylinder.

In some embodiments the IFP avoids the complexity and inaccuracy of current off-vehicle CNG dispensing systems, which typically involve predictive algorithms and cannot take into account differences in cylinder construction such as Type 1 Steel vs Type 4 Composite cylinders. Further, according to some embodiments the IFP avoids the complexity of maintaining communications between vehicle and dispenser.

Certain embodiments of the present invention provide accurate information as to the amount of natural gas in a CNG tank and can thus enable good operational decision making. Similarly, consistent filling outcomes can be provided, resulting in simplified planning.

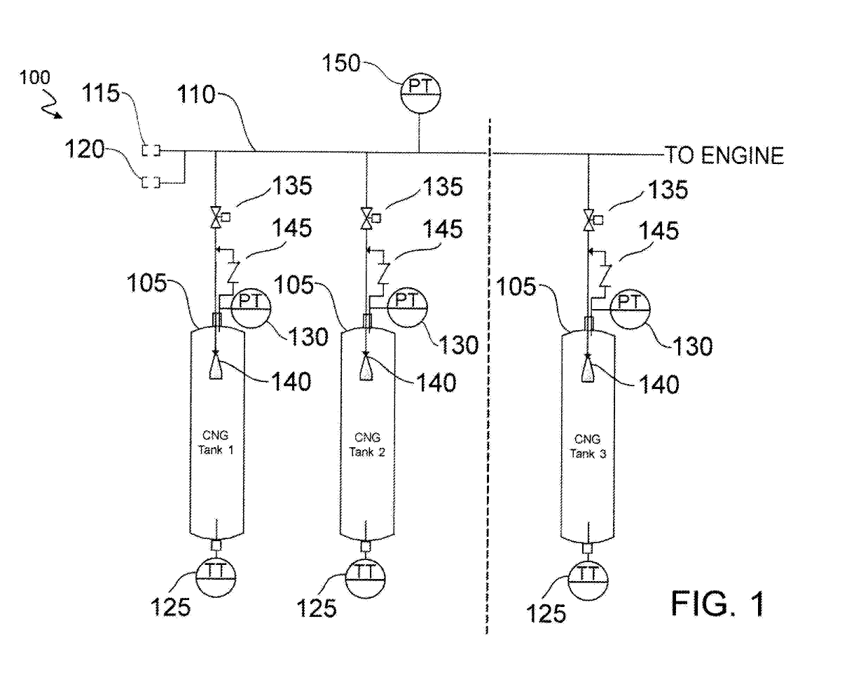

FIG. 1 diagrammatically illustrates a CNG storage system 100 that can receive fuel from a dispenser (not shown) and can supply gas to a gas consuming device, for example an engine (not shown). The CNG storage system 100 can be mobile on vehicle or stationary off vehicle.

The CNG storage system 100 comprises a plurality of interconnected pressure vessels 105 in the form of CNG tanks. A gas header 110 is used to connect the pressure vessels 105 to the gas consuming engine and to refuelling ports in the form of a 350 barg connector 115 and a 250 barg connector 120. The refuelling ports, and in particular the presence of both the 350 barg connector 115 and the 250 barg connector 120, enable the pressure vessels 105 to be filled using 250 barg dispensing systems and 350 barg dispensing systems, as discussed further below.

The CNG system 100 comprises a plurality of sensors in the form of temperature sensors 125, pressure sensors 130 and a gas header pressure sensor 150. The temperature sensors 125 are for measuring a temperature of the gas in the pressure vessels 105 and the pressure sensors 130 are for measuring a pressure of the gas in the pressure vessels 105. The gas header pressure sensor 150 is for measuring the pressure of the gas in the gas header 110.

One or more temperature sensors 125 and/or pressure sensors 130 can be connected to each pressure vessel 105. Alternatively, a single temperature sensor 125 and/or pressure sensor 130 can be used to measure a temperature or pressure associated with several pressure vessels 105. In such case, a temperature and/or pressure of a first pressure vessel 105 can be indicative of a temperature and/or pressure of a second pressure vessel 105.

As discussed further below, a temperature and pressure of the pressure vessels 105 can be used to determine when an amount of gas in the pressure vessels 105 has reached a point where, if allowed to cool to 21° C., the pressure would equal 350 Barg. Furthermore, a mass of CNG in the pressure vessels can be calculated by multiplying a CNG density, determined by pressure and temperature, by the water volume of the pressure vessels 105. The amount of gas in the pressure vessels 105 can, for example, be used to provide an accurate indicator of remaining gas to a user.

The compressed natural gas system 100 further comprises a plurality of shut-off valves 135, between the gas header 110 and each of the pressure vessels 105, for controlling a flow of gas between the gas header 110 and the pressure vessels 105. The shut-off valves 135 can be used to control filling of the pressure vessels 105, as discussed below, and prevent overfilling of the pressure vessels 105.

A controller (not shown) is used to control the shut off valves 135 according to input from the temperature sensors 125 and the pressure sensors 130 as discussed further below.

The pressure vessels 105 further comprise nozzles 140, wherein the pressure vessels 105 and nozzles 140 are thermally coupled such that Joule-Thomson expansion of gas flowing through the nozzles 140 cools gas inside the pressure vessels 105. The nozzles 140 can, for example, comprise De Laval nozzles located inside the tanks such that Joule-Thomson expansion of the gas occurs inside of the pressure vessels 105.

According to some embodiments, the nozzles 140 are calibrated such that the plurality of pressure vessels 105 fill at a same rate when all of the shut off valves 135 are open.

The system 100 further includes a plurality of check valves 145, coupling the pressure vessels 105 and the gas header 110. The check valves 145 prevent CNG from bypassing the nozzles 140 when filling the pressure vessels, while providing a large gas exit flow path relative to the nozzles 140.

As discussed further below, if a pressure of the gas header 110 is below a threshold, one or more valves 135 can be shut to increase the pressure in the gas header 110 to ensure maximum Joule-Thomson effect at the pressure vessels 105 during filling.

During refilling of the pressure vessels 105, the controller can determine a percentage of gas in the pressure vessels 105 relative to an amount of gas in a settled full fill (e.g., a nameplate fill at 21 degrees C.). When the controller determines that the pressure vessels 105 are full, the shut-off valves 135 are closed causing the flow of gas from the dispenser to cease and thus cause the dispenser to shut off. As will be readily understood by the skilled addressee, the dispenser may also be shut off due to a low flow condition when the pressure in the pressure vessels 105 equalises with a supply pressure in the gas header 110.

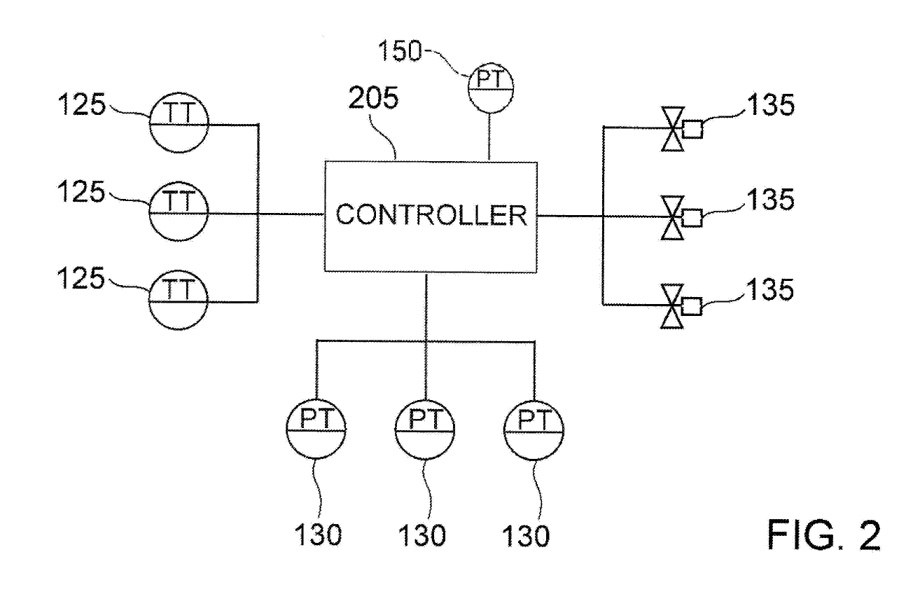

FIG. 2 diagrammatically illustrates a control portion of the system 100 of FIG. 1, according to an embodiment of the present invention. The system 100 further includes a controller 205, configured to control the shut off valves 135.

In particular, the controller 205 is configured to activate (i.e. shut) a shut-off valve 135 when one of the following occurs: a pressure of the corresponding pressure vessel 105 is above a predefined threshold; a temperature of the corresponding pressure vessel 105 is above a predefined threshold; or the pressure of the pressure vessel 105 reaches a point where, if allowed to settle (e.g. cool to 21° C.) the pressure would equal a predefined pressure, such as 350 barg. Those skilled in the art will understand that the various predefined thresholds of pressure and temperature may vary depending on a particular gas composition.

According to one embodiment, the controller 205 is configured to activate a shut-off valve 135 when an amount of gas in the corresponding pressure vessel 105 corresponds to a predefined settled pressure-temperature combination. As will be readily understood by the skilled addressee, for a given amount of gas, a pressure is dependent on the temperature of the gas. Accordingly, for each temperature of a plurality of temperatures, a pressure threshold can be used to determine when to activate the shut-off valve 135. Such temperature-pressure thresholds can be provided in temperature-pressure maps that map temperature to pressure. In such case, the map includes a plurality of pressure-temperature pairs, wherein each of the plurality of pressure-temperature pairs corresponds to an amount of CNG, which, if allowed to cool to 21° C., would equal the nominal service pressure rating of the vessel 105, or about 350 barg depending on the rating of the pressure vessel 105.

As an illustrative example, the controller 205 can be configured to activate the shut-off valve 135 when an amount of gas in the corresponding pressure vessel 105 corresponds to a settled pressure of 350 barg at 21° C. Similarly, the shut-off valve 135 can be activated when the temperature of the corresponding pressure vessel 105 reaches its maximum allowed temperature of 82° C., or when the pressure of the corresponding pressure vessel 105 reaches its maximum allowed pressure of 438 barg, or about 1.25 times the nominal service pressure of the pressure vessel 105.

This enables use of a simple dispenser that shuts off on a loss of flow condition, as a result of the shut-off valves 135 closing, without the need for electrical communications between the vehicle and the dispenser.

Once all of the shut off valves 135 are closed, no gas is able to enter the pressure vessels 105 and the external filling system will detect a loss of flow condition at the refueling ports and shut off a supply of gas to the CNG system 100. The controller 205 can also alert a user that the fill is complete and to disconnect the re-fuelling hose.

The controller 205 is further configured to control the shut off valves 135 according to a pressure in the gas header 110, as detected by the as header pressure sensor 150. According to certain embodiments, the controller 205 is configured to activate (i.e. shut) one or more shut-off valves 135 when a pressure of the gas header 110 is below a predefined threshold. This occurs when the CNG flow available to the dispenser is below the sum of the calibrated flow rates for the nozzles 140 and the controller consequently activates one or more shut-off valves 135 to reduce the flow potential into the cylinders and allowing the pressure of the gas header 110 to increase. This is advantageous in maintaining a high upstream pressure that achieves supersonic flow of gas into the pressure vessels 105 when a De Laval nozzle is used.

According to certain embodiments, the controller 205 is further configured to calculate a mass of gas in the pressure vessels 105 according to signals of the temperature sensors 125 and pressure sensors 130, and a volume of the pressure vessels 105, as the gas is consumed. For example, the controller 205 can be configured to periodically estimate a mass of the gas in the pressure vessels 105 and provide an output corresponding to the mass on an output interface, such as an in-cabin display of a vehicle. The mass can be presented to the user in a number of suitable ways, including as diesel gallon equivalents (DGE).

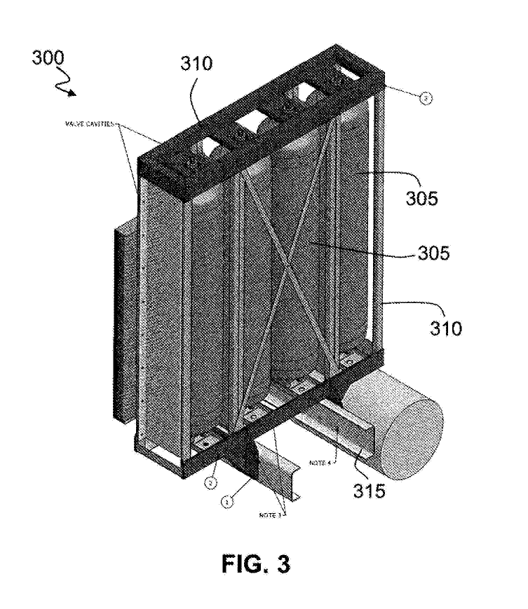

FIG. 3 illustrates a CNG system 300, according to certain embodiments of the present invention. For example, the CNG system 300 can be similar to the CNG system 100 of FIG. 1.

The CNG system 300 comprises a plurality of pressure vessels 305 vertically mounted in a frame 310. The pressure vessels 305 can, for example, be adapted to be fitted to a chassis rail 315 of a prime mover, behind a cabin or sleeper. However, according to alternative embodiments (not shown) the pressure vessels 305 can be adapted to be mounted horizontally.

The pressure vessels 305 can, for example, comprise Lincoln Composites (LC) 18″×97″ or 26″×100″ Type 4 Composite 350 barg cylinders.

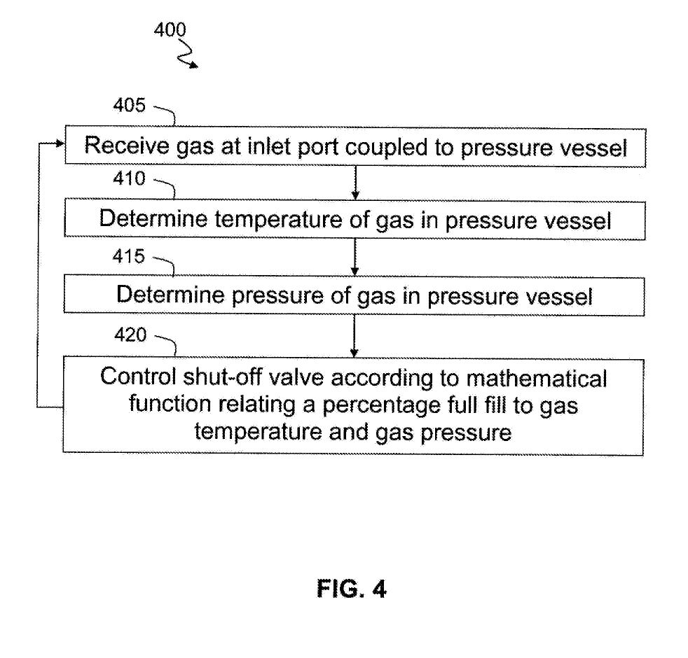

FIG. 4 illustrates a method 400 of filling of a pressure vessel on board a vehicle, according to an embodiment of the present invention. The pressure vessel can comprise a pressure vessel of a plurality of interconnected pressure vessels, such as the pressure vessels 105 of FIG. 1 or the pressure vessels 305 of FIG. 3.

At step 405, gas is received at an inlet port coupled to a pressure vessel.

At step 410, a temperature of the pressure vessel is determined. As discussed above, the temperature can be determined directly, from a sensor inside the pressure vessel, or indirectly, from a sensor in association with the pressure vessel.

At step 415, a pressure of the pressure vessel is determined. As discussed above, the pressure can be determined from a pressure sensor located inside the pressure vessel, or in plumbing associated with the pressure vessel.

At step 420, a shut-off valve is controlled according to a percentage of gas in the pressure vessel relative to a settled and fully filled vessel, which is determined according a mathematical function relating a percentage full fill to the gas temperature and pressure. Such mathematical functions are well known in the art.

Suitably, the amount of gas corresponds to a settled pressure of 350 barg at 21° C. The shut-off valve is generally located between a refuelling port and the pressure vessel, and thus controls a flow of gas between the refuelling port and the pressure vessel.

The method 400 then cycles back to step 405 until the filling process is complete.

In particular and according to certain embodiments, the shut off valve is engaged (i.e., shut) upon determination of one or more of the following: a pressure of the pressure vessel reaches a predefined threshold; a temperature of the pressure vessel reaches a predefined threshold; or when an amount of gas in the pressure vessel corresponds to a settled pressure of 350 barg at 21° C.

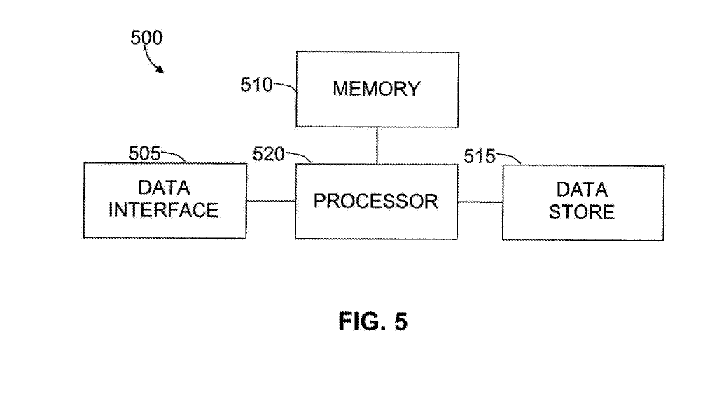

FIG. 5 diagrammatically illustrates a controller 500, according to an embodiment of the present invention. The controller 500 can be similar to the controller 205 of FIG. 2. Similarly, the method 400 can be executed using the controller 500.

The controller 500 includes a data interface 505, a memory 510, a data store 515 and a processor 520. The processor 520 is coupled to the data interface 505, memory 510, and data store 515.

The data interface 505 provides an interface to sensors, such as the temperature sensors 125 and pressure sensors 130, and to valves, such as the shut-off valve 135 of FIG. 1. The processor 520 is able to process temperature and pressure data from the temperature sensors 125 and pressure sensors 130, for example, and control, for example, the shut-off valve 135 based thereon.

The processor 520 processes computer readable program code components stored in the memory 515 and implements various methods and functions as described herein. Examples of functions include determining an amount of gas in a pressure vessel, and determining when to activate a shut-off valve based upon a pressure and temperature of a gas.

The data store 515 includes data, such as predefined threshold data, or any other persistent or dynamic data. As will be understood by a person skilled in the art, a single memory, such as the memory 510, can be used to store both dynamic and static data

The controller 500 can include a system bus (not shown) that couples various system components, including coupling the memory 510 to the processor 520. The system bus can be any of several types of bus structures including a memory bus or memory controller, a peripheral bus, and a local bus using any of a variety of bus architectures.

The processor 520 and memory 510 can be replaced by dedicated hardware, and the controller 500 can include software, hardware, firmware, or any combination thereof.

The structure of system memory 510 is well known to those skilled in the art and can include a basic input/output system (BIOS) stored in a read only memory (ROM) and one or more program modules such as operating systems, application programs and program data stored in random access memory (RAM).

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A vehicle mounted system for receiving a compressed gas, the system comprising:
a refuelling port, for receiving the compressed gas;
a pressure vessel, coupled to the refuelling port, for storing the compressed gas;
a shut-off valve, between the refuelling port and the pressure vessel, for controlling a flow of gas between the refuelling port and the pressure vessel;
a pressure sensor for determining a pressure inside the pressure vessel;
a temperature sensor for determining a temperature associated with the pressure vessel;
a nozzle, wherein the pressure vessel and nozzle are thermally coupled such that Joule-Thomson expansion of a gas flowing through the nozzle cools an interior cavity of the pressure vessel; and
a controller coupled to the pressure sensor, the temperature sensor and the shut-off valve, the controller configured to selectively activate the shut-off valve according to an amount of gas in the pressure vessel determined according to values of the pressure sensor and the temperature sensor.

2. The system of claim 1, wherein the controller is further configured to activate the shut-off valve when a pressure of the pressure vessel is above a predefined pressure threshold.

3. The system of claim 2, wherein the predefined pressure threshold is about 1.25 times the nominal service pressure of the pressure vessel.

4. The system of claim 1, wherein the controller is further configured to activate the shut-off valve when a temperature of the pressure vessel is above a predefined temperature threshold.

5. The system of claim 4, wherein the predefined temperature threshold is about 82° C.

6. The system of claim 1, wherein the amount of gas is determined according to a map that maps a temperature to a pressure.

7. The system of claim 6, wherein the map includes a plurality of pressure-temperature pairs.

8. The system of claim 7, wherein each of the plurality of pressure-temperature pairs corresponds to an amount of CNG, which, if allowed to cool to 21° C., would equal about the nominal service pressure of the pressure vessel.

9. The system of claim 6, wherein the map corresponds to a mathematical function that includes pressure, temperature and gas composition as input variables.

10. The system of claim 1, further comprising a plurality of pressure vessels.

11. The system of claim 10, wherein the refuelling port is coupled to the plurality of pressure vessels.

12. The system of claim 10, wherein the system includes a header pressure sensor for determining a pressure of a gas header connected to an inlet port of each vessel of the plurality of pressure vessels.

13. The system of claim 12, wherein the controller is further configured to control the shut off valve according to a pressure in the gas header.

14. The system of claim 13, wherein the controller is configured to activate the shut-off valve when a pressure of the gas header is below a predefined threshold.

15. The system of claim 1, further comprising a plurality of pressure vessels, wherein each of the plurality of pressure vessels comprises a nozzle, and wherein the nozzles are each calibrated such that the plurality of pressure vessels fill at a same rate.

16. The system of claim 1, wherein the controller is further configured to calculate a mass of gas in the pressure vessel according to the sensors and volume of the pressure vessel, and provide an indication of a diesel gallon equivalent (DGE) or diesel litre equivalent (DLE) of the gas in the pressure vessel on an output interface.

17. The system of claim 1, wherein the pressure vessel is a compressed natural gas (CNG) pressure vessel.

18. The system of claim 1, wherein the temperature sensor is positioned at one end of the pressure vessel and the nozzle is positioned at an opposite end of the pressure vessel.

19. A method of filling a pressure vessel on board a vehicle including:
receiving a gas at a refuelling port, wherein the refuelling port is coupled to the pressure vessel;
determining a temperature of the pressure vessel,
determining a pressure of the pressure vessel;
directing the gas through a nozzle, wherein the pressure vessel and nozzle are thermally coupled such that Joule-Thomson expansion of a gas flowing through the nozzle cools an interior cavity of the pressure vessel; and
controlling a shut-off valve according to an amount of gas in the pressure vessel determined according to the temperature and pressure, wherein the shut-off valve is located between the refuelling port and the pressure vessel, for controlling a flow of gas between the refuelling port and the pressure vessel.
